(19) United States
(12) Patent Application Publication
(10) Pub. No.: US 2026/0172647 A1
(43) Pub. Date: Jun. 18, 2026

(54) METHOD AND APPARATUS FOR AUTOMATED VIDEO PRODUCTION

(71) Applicant: Electronics and Telecommunications Research Institute, Daejeon (KR)

(72) Inventors: Soon Choul KIM, Daejeon (KR); Hye Ju OH, Daejeon (KR)

(73) Assignee: Electronics and Telecommunications Research Institute, Daejeon (KR)

(21) Appl. No.: 19/377,496

(22) Filed: Nov. 3, 2025

(30) Foreign Application Priority Data
Dec. 13, 2024 (KR) 10-2024-0185999
Jun. 11, 2025 (KR) 10-2025-0076424

(51) Int. Cl. H04N 21/81; G06V 40/16; G10L 15/14; H04N 21/854

(52) U.S. Cl. CPC H04N 21/816; G06V 40/161; G06V 40/171; G10L 15/14; H04N 21/854

(57) ABSTRACT

A method and apparatus for automated video production. An aspect of the present disclosure provides a method for automated video production, comprising: calculating, for each of a plurality of time steps, a first probability value indicating a speech probability of a first object included in each of first frames included in each time step, and a second probability value indicating a speech probability of a second object included in each of second frames included in each time step; selecting, for each of the plurality of time steps, one frame set from among the first frames included in each time step, the second frames included in each time step, and third frames included in each time step, based on the first probability value and the second probability value; generating a final video based on a plurality of frame sets selected for the plurality of time steps; and outputting the final video, wherein each of the first frames includes the first object, each of the second frames includes the second object, and each of the third frames includes both the first object and the second object.

### CROSS-REFERENCE TO RELATED APPLICATIONS

This application claims priority from Korean Patent Application No. 10-2024-0185999 filed on December 13, 2024, and Korean Patent Application No. 10-2025-0076424 filed on June 11, 2025, the disclosures of which are incorporated by reference herein in their entirety.

### TECHNICAL FIELD

The present disclosure relates to a method and apparatus for automated video production.

### BACKGROUND

The statements in this section merely provide background information related to the present disclosure and do not necessarily constitute prior art.

In conventional media production systems, a producer directly edits video captured by multiple cameras to generate a final program (PGM) video. The producer monitors preview (PRV) video while selecting appropriate footage based on whether a speaker is speaking and the flow of the content, then outputs the selected video as program video. However, this method requires continuous intervention of the producer and poses a significant workload burden in environments where live broadcasting or a large amount of video content needs to be processed.

Recently, with increasing interest in media production automation, technology for automatically selecting appropriate frames using video analysis technology in multi-camera environments has been studied. However, conventional video analysis technology has been focused on recognizing specific objects or scenes, and thus has limitations in accurately determining whether a speaker is speaking and generating an optimal program video based thereon.

Therefore, there is a need for a method and apparatus for video production capable of analyzing videos captured by multiple cameras, determining in real time whether a speaker is speaking, and automatically selecting an appropriate video.

### SUMMARY

An object of the present disclosure is to provide a method and apparatus for automated video production. Specifically, an object of the disclosure is to provide a method and apparatus that, by calculating probability values indicating speaking probabilities of respective speakers from videos captured by multiple cameras, selecting a video captured by a specific camera based on the calculated probability values, and generating a final video by connecting the selected videos for each time step, may automatically select an appropriate video for each time step without intervention of a producer, and generate and output a final video based thereon.

The technical objects of the present disclosure are not limited to those described above, and other technical objects not mentioned above may be understood clearly by those skilled in the art from the descriptions given below.

An embodiment of the present disclosure provides a method for automated video production, comprising: calculating, for each of a plurality of time steps, a first probability value indicating a speech probability of a first object included in each of first frames included in each time step, and a second probability value indicating a speech probability of a second object included in each of second frames included in each time step; selecting, for each of the plurality of time steps, one frame set from among the first frames included in each time step, the second frames included in each time step, and third frames included in each time step, based on the first probability value and the second probability value; generating a final video based on a plurality of frame sets selected for the plurality of time steps; and outputting the final video, wherein each of the first frames includes the first object, each of the second frames includes the second object, and each of the third frames includes both the first object and the second object.

Another embodiment of the present disclosure provides an apparatus for automated video production, comprising: at least one memory storing instructions; and at least one processor configured to execute the instructions to perform operations comprising: calculating, for each of a plurality of time steps, a first probability value indicating a speech probability of a first object included in each of first frames included in each time step, and a second probability value indicating a speech probability of a second object included in each of second frames included in each time step; selecting, for each of the plurality of time steps, one frame set from among the first frames included in each time step, the second frames included in each time step, and third frames included in each time step, based on the first probability value and the second probability value; generating a final video based on a plurality of frame sets selected for the plurality of time steps; and outputting the final video, wherein each of the first frames includes the first object, each of the second frames includes the second object, and each of the third frames includes both the first object and the second object.

According to an embodiment of the present disclosure, it is possible to improve efficiency of video production by determining whether a speaker is speaking in real time and automatically selecting appropriate video based on the determination.

According to an embodiment of the present disclosure, it is possible to reduce the cost of video production by automatically selecting an optimal frame at each time step.

According to an embodiment of the present disclosure, it is possible to improve quality of the video by selecting an optimal frame at each time step to generate a final image.

According to an embodiment of the present disclosure, it is possible to precisely determine whether a speaker is speaking by analyzing a speech probability based on lip feature points of an object.

The technical effects of the present disclosure are not limited to the technical effects described above, and other technical effects not mentioned herein may be understood to those skilled in the art to which the present disclosure belongs from the description below.

### BRIEF DESCRIPTION OF THE DRAWINGS

FIG. 1 is a diagram schematically showing a configuration of an apparatus for video production according to an embodiment of the disclosure.

FIG. 2 is a diagram illustrating first frames, second frames, and third frames for a plurality of time steps according to an embodiment of the disclosure.

FIG. 3 is a diagram illustrating a first frame, a second frame, and a third frame according to an embodiment of the disclosure.

FIG. 4 is a diagram illustrating a face region and a lip region detected from a frame according to an embodiment of the disclosure.

FIG. 5 is a diagram for explaining a process of selecting target frames from original frames according to an embodiment of the disclosure.

FIG. 6A is a diagram for explaining operations of a preprocessing module and a speech probability calculation module according to an embodiment of the disclosure.

FIG. 6B is a diagram for explaining the operation of a preprocessing module and a speech probability calculation module according to another embodiment of the disclosure.

FIG. 7 is a diagram for explaining operations of a frame selection module and a final video generation module according to an embodiment of the disclosure.

FIG. 8A is a diagram for explaining a smoothing process according to an embodiment of the disclosure.

FIG. 8B is a diagram for explaining a smoothing process according to an embodiment of the disclosure.

FIG. 8C is a diagram for explaining a smoothing process according to an embodiment of the disclosure.

FIG. 8D is a diagram for explaining a smoothing process according to an embodiment of the disclosure.

FIG. 8E is a diagram for explaining a smoothing process according to an embodiment of the disclosure.

FIG. 9 is a flowchart schematically showing a video production method according to an embodiment of the disclosure.

FIG. 10 is a block diagram illustrating an exemplary computing device that may be used for implementing a method or an apparatus according to the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

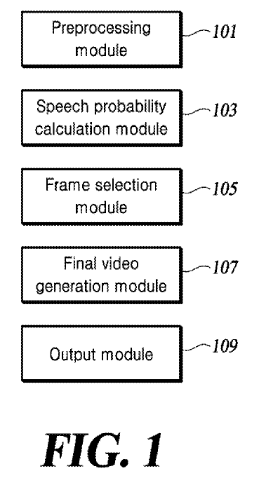

FIG. 1 is a diagram schematically showing a configuration of an apparatus for video production according to an embodiment of the disclosure.

Referring to FIG. 1, an apparatus for video production according to an embodiment of the disclosure may include a preprocessing module 101, a speech probability calculation module 103, a frame selection module 105, a final video generation module 107, and an output module 109.

The preprocessing module 101 may acquire a video. The video may be acquired from one or more capturing devices. The capturing device may be a camera. The video may be classified into several types of videos based on the capturing device from which the video is acquired. For example, the video may include a first video, a second video, and a third video; and the first video may be a video acquired from a first camera, the second video may be a video acquired from a second camera, and the third video may be a video acquired from a third camera. The capturing devices may capture different scenes in the same situation. For example, in a situation where a first object and a second object are having a conversation, the first camera may capture the upper body of the first object, the second camera may capture the upper body of the second object, and the third camera may capture the upper bodies of the first object and the second object in a single scene. One or more capturing devices, i.e., one or more cameras, may be referred to as a multi-camera.

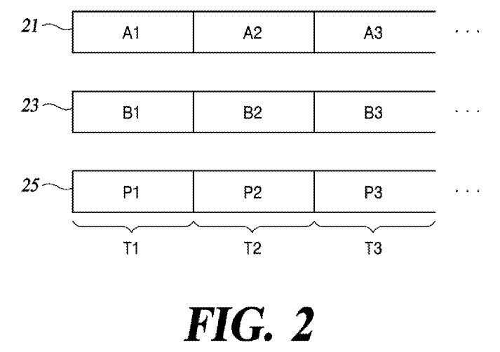

FIG. 2 is a diagram illustrating first frames, second frames, and third frames for a plurality of time steps according to an embodiment of the disclosure.

Referring to FIG. 2, a first video 21, a second video 23, and a third video 25 are illustrated. Each of the first video 21, the second video 23, and the third video 25 may be divided into a plurality of time steps. For example, the first video 21 may include A1, which is a video for time step T1, A2, which is a video for time step T2, and A3, which is a video for time step T3. The time length of T1, the time length of T2, and the time length of T3 may all be the same. For example, the time length of T1, the time length of T2, and the time length of T3 may all be 1 second. In other words, assuming that a variable t represents the capture time of the first camera, A1 included in the first video 21 may be a video taken for 1 second from the time when the first camera starts capturing (t=0) to the time when 1 second has elapsed after the first camera starts capturing (t=1). A2 may be a video taken for 1 second from the time when 1 second has elapsed after the first camera starts capturing (t=1) to the time when 2 seconds have elapsed after the first camera starts capturing (t=2). A3 may be a video taken for 1 second from the time when 2 seconds have elapsed after the first camera starts capturing (t=2) to the time when 3 seconds have elapsed after the first camera starts capturing (t=3).

The first frames may be a plurality of frames included in the first video 21. For example, A1 may include the first frames contained in the time step T1 among the first frames. The second frames may be a plurality of frames included in the second video 23. For example, B1 may include the second frames contained in the time step T1 among the second frames. The third frames may be a plurality of frames included in the third video 25. For example, P1 may include the third frames contained in the time step T1 among the third frames.

Meanwhile, in the disclosure, the number of cameras and the types of videos according to the number of cameras are illustrated as three, and the number of time steps included in each video is illustrated as three, but this is merely for the convenience of explanation and is not intended to limit the scope of the invention.

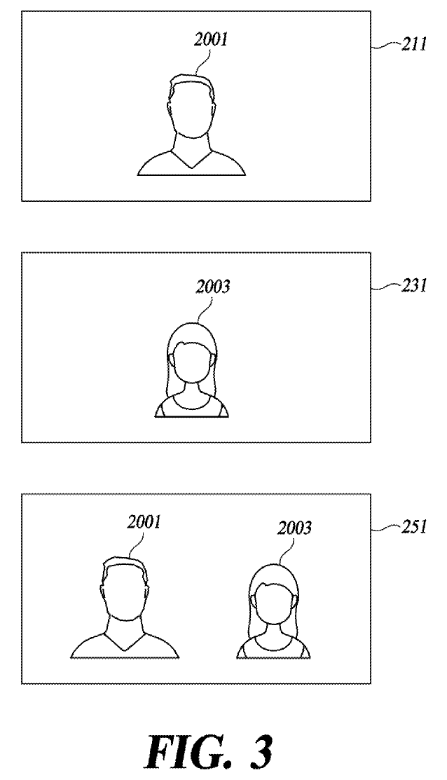

FIG. 3 is a diagram illustrating a first frame, a second frame, and a third frame according to an embodiment of the disclosure.

Referring to FIG. 3, a first frame 211, a second frame 231, and a third frame 251 are illustrated. The first frame 211 may be any one of the first frames included in the first video 21. The second frame 231 may be any one of the second frames included in the second video 23. The third frame 251 may be any one of the third frames included in the third video 25. The first frame 211 may include a first object 2001. The second frame 231 may include a second object 2003. The third frame 251 may include the first object 2001 and the second object 2003. The first object 2001 and the second object 2003 may be different persons. The first frame 211, the second frame 231, and the third frame 251 may be frames captured at the same time using different capturing devices.

The preprocessing module 101 may detect one or more of a face region and a lip region from a frame. The frame may include an object. The object may be a person. That is, the preprocessing module 101 may detect one or more of a region indicating a face of a person and a region indicating lips of a person from a frame in which the person is captured. The face region or the lip region may be a region of interest (ROI). For detection of the face region, the preprocessing module 101 may generate three-dimensional coordinates of a face. The preprocessing module 101 may extract one or more lip feature points from the lip region. The preprocessing module 101 may include a feature extractor (not shown). The feature extractor may extract a feature related to the speaking status from an input video. The feature related to the speaking status may be lip feature points. The feature extractor may be implemented using a convolutional neural network (CNN) including a plurality of convolutional layers. In some embodiments, in order to prevent overfitting, the feature extractor may further include a dropout layer located between the plurality of convolutional layers. In addition, in order to reduce computational burden while leaving only important information, the feature extractor may further include a pooling layer located between the plurality of convolutional layers. As the depth of the layers in the feature extractor increases, the size of a feature map generated by each convolutional layer may become smaller, and the number of filters of the convolutional layers may increase.

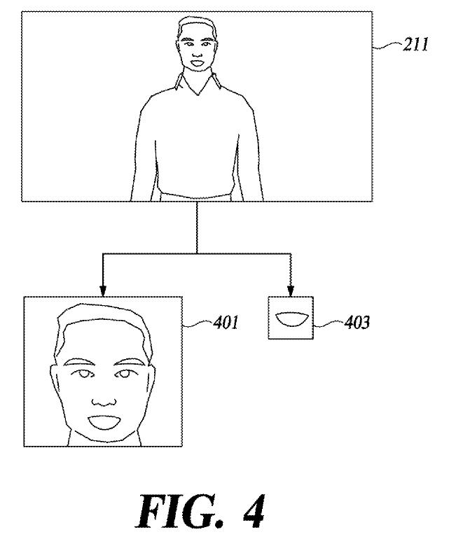

FIG. 4 is a diagram illustrating a face region and a lip region detected from a frame according to an embodiment of the disclosure.

Referring to FIG. 4, a face region 401 and a lip region 403 detected from the first frame 211 are illustrated. The preprocessing module 101 may detect one or more of a region 401 including a face of a first object and a region 403 including lips of the first object from the first frame 211 in which an upper body of the first object is captured. The preprocessing module 101 may be implemented using part of or all of one or more computing devices 100.

The speech probability calculation module 103 may calculate a speech probability of the object based on lip feature points. The speech probability calculation module 103 may include a classifier (not shown). The classifier may output a classification result regarding the speech status using an input feature map. The feature map may be lip feature points. The classifier may include one or more fully connected layers. The classifier may flatten a multi-dimensional form of feature map extracted by the feature extractor into array-type data, and then calculate a probability value that speech is present and/or a probability value that speech is not present in the input video through weighted operations using the fully connected layer. To this end, the final output layer of the classifier may use a sigmoid function or a softmax function to calculate the probability value that speech is present and/or the probability value that speech is not present, but is not limited thereto. The speech probability calculation module 103 may be implemented using part of or all of one or more computing devices 100.

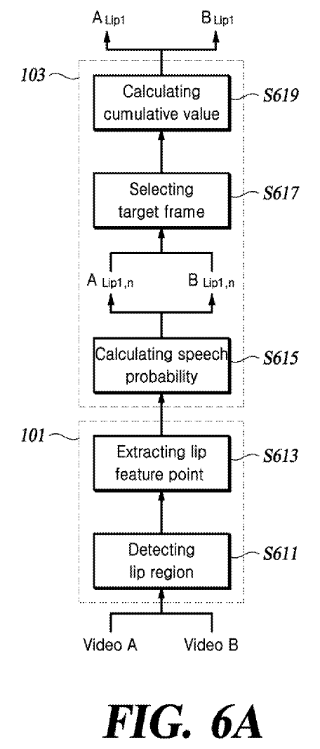

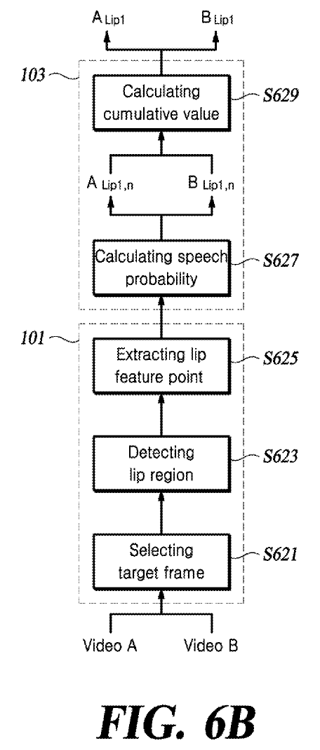

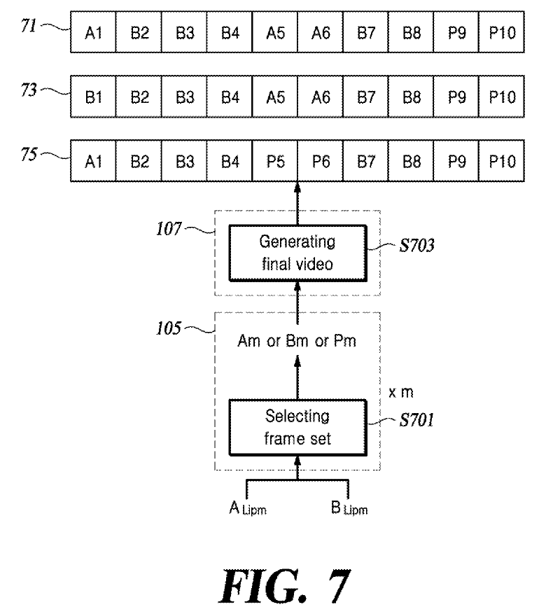

The frame selection module 105 may select a frame set based on the speech probability of the object. The speech probability of the object may be calculated for each frame. For example, when the number of frames included in A1 is 30, the speech probability calculation module 103 may calculate the speech probability of the first object for each of the 30 frames. The frame selection module 105 may accumulate the speech probability of the object calculated for each frame to calculate a cumulative value representing the speech probability of the corresponding object for each object, and may select one frame set based on the cumulative value of the object. A process of calculating a cumulative value based on probability values and selecting one frame set based on the cumulative value will be described in detail below with reference to FIG. 6A, FIG. 6B, and FIG. 7. The frame selection module 105 may be implemented using part or all of one or more computing devices 100.

The final video generation module 107 may generate a final video based on the selected plurality of frame sets. The final video generation module 107 may generate the final video by arranging and merging the selected plurality of frame sets in chronological order. The final video generation module 107 may be implemented by using part or all of one or more computing devices 100.

The output module 109 may output the final video. Optionally, the output module 109 may output the final video in which a smoothing process has been performed. The output module 109 is a device capable of displaying video data and may include, for example, one or more of a display panel, a projector, a head-up display (HUD), or a display module of an augmented reality (AR) and virtual reality (VR) device. The output module 109 may receive video signals and display them on a screen and may provide optimal visual information by adjusting resolution, brightness, color, etc., as needed. In addition, the output module 109 may include wired and wireless interfaces for linkage with an external display device and may be compatible with various output methods such as High-Definition Multimedia Interface (HDMI), DisplayPort, Mobile Industry Processor Interface Display Serial Interface (MIPI DSI), and Wi-Fi Display.

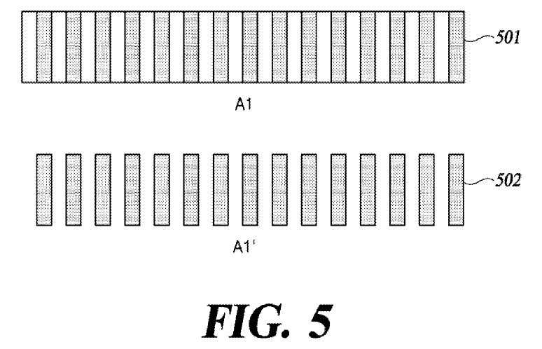

FIG. 5 is a diagram for explaining a process of selecting target frames from original frames according to an embodiment of the disclosure.

One or more of the preprocessing module 101 and the speech probability calculation module 103 may select target frames. According to a first embodiment, the speech probability calculation module 103 may select target frames. According to a second embodiment, the preprocessing module 101 may select target frames. The process in which the preprocessing module 101 selects target frames and the process in which the speech probability calculation module 103 selects target frames may be the same process except for the difference in the subject.

Referring to FIG. 5, original frames 501 and target frames 502 are illustrated. The original frames 501 may be frames included in a video acquired from a capturing device. For example, among the first frames included in the first video 21, frames A1 for the time step T1 may be the original frames 501. The original frames 501 may include 30 frames. In other words, A1 may be a video in which 30 frames are captured for 1 second.

One or more of the preprocessing module 101 and the speech probability calculation module 103 may select target frames 502 among the original frames 501. One or more of the preprocessing module 101 and the speech probability calculation module 103 may select the target frames 502 based on effective time. One or more of the preprocessing module 101 and the speech probability calculation module 103 may calculate the number of frames to be included in the target frames 502 by multiplying a value obtained by dividing the effective time by the time length of the original frames 501 by the number of frames included in the original frames 501, and may select the target frames 502 among the frames included in the original frames 501 based on the calculated number of frames. For example, when the effective time is 0.5 seconds, one or more of the preprocessing module 101 and the speech probability calculation module 103 may multiply 0.5 by 30 to calculate 15, and may select 15 frames among the 30 frames included in the original frames 501 as the target frames 502. The target frames 502 may be even-numbered frames among the original frames 501. The target frames 502 may be frames for the same time step as the original frames 501. For example, when the original frames 501 are frames for the time step T1, the target frames 502 may also be frames for the time step T1. Frames A1′ for the time step T1 may be the target frames 502. The target frames 502 may be a part of the original frames 501.

FIG. 6A is a diagram for explaining operations of a preprocessing module and a speech probability calculation module according to an embodiment of the disclosure. FIG. 6A may represent the operation of the preprocessing module and the speech probability calculation module in a specific time step. For example, FIG. 6A may represent the operation of the preprocessing module and the speech probability calculation module in the time step T1, and the processes disclosed in FIG. 6A may be repeatedly performed for each time step. Hereinafter, it is assumed that the processes disclosed in FIG. 6A are processes performed during the time step T1.

Referring to FIG. 6A, the preprocessing module 101 may acquire first frames and second frames included in the time step T1. The first frames included in the time step T1 are expressed as Video A in FIG. 6A, and the second frames included in the time step T1 are expressed as Video B in FIG. 6A. Video A may be A1 of FIG. 2, and Video B may be B1 of FIG. 2.

The preprocessing module 101 may detect one or more of face regions or lip regions of an object from the acquired first frames and second frames. The preprocessing module 101 may detect lip regions of a first object from the acquired first frames, and may detect lip regions of a second object from the acquired second frames (S611). The preprocessing module 101 may extract one or more lip feature points from the lip regions of the first object, and may extract one or more lip feature points from the lip regions of the second object (S613).

The speech probability calculation module 103 may acquire the lip feature points extracted by the preprocessing module 101. The lip feature points for the first frames and the lip feature points for the second frames may be distinguished from each other.

The speech probability calculation module 103 may calculate a speech probability of a first object based on lip feature points for the first frames, and may calculate a speech probability of a second object based on lip feature points for the second frames (S615). The speech probability may be calculated for each frame. For example, the speech probability calculation module 103 may calculate the speech probability of the first object for an n-th frame among the first frames, may calculate the speech probability of the second object for an n-th frame among the second frames, and may repeatedly perform the above processes for each frame. n may be the number of frames included in the first frames or the number of frames included in the second frames. For example, when the number of frames included in A1 is 30 and the number of frames included in B1 is also 30, the speech probability calculation module 103 may perform a process of calculating the speech probability of the first object and the speech probability of the second object for each of the 1st to 30th frames, respectively. The speech probability of the first object for the n-th frame may be ALip1,n, and the speech probability of the second object calculated for the n-th frame may be BLip1,n. The speech probability of the first object calculated for a specific frame may be a first probability value. The speech probability of the second object calculated for a specific frame may be a second probability value. That is, the speech probability calculation module 103 may calculate, for each of the first frames included in each time step, a first probability value indicating the speech probability of the first object, and for each of the second frames included in each time step, a second probability value indicating the speech probability of the second object. The first probability value and the second probability value for each frame may be matched to each frame and stored as information for each frame.

The process of calculating the speech probability of the first object based on the lip feature points extracted from the lip regions of the first object included in the first frames and the process of calculating the speech probability of the second object based on the lip feature points extracted from the lip regions of the second object included in the second frames may be performed as separate processes simultaneously. That is, the process of calculating the speech probability of the first object based on the lip feature points extracted from the lip regions of the first object included in the first frames and the process of calculating the speech probability of the second object based on the lip feature points extracted from the lip regions of the second object included in the second frames may be performed in parallel.

The speech probability calculation module 103 may select first target frames among the plurality of frames included in the first frames and may select second target frames among the plurality of frames included in the second frames, based on effective time (S617). Since the process of selecting target frames from original frames has been described with reference to FIG. 5, the description thereof will be omitted herein. For example, when the effective time is 0.5 seconds, the speech probability calculation module 103 may select 15 frames, which are even-numbered frames, among 30 frames included in A1, and may select 15 frames, which are even-numbered frames, among 30 frames included in B1. The target frames selected from A1 may be expressed as A1′, and the target frames selected from B1 may be expressed as B1′. Since the target frames are part of the original frames, the speech probability of the object included in each frame may have already been calculated for the selected frames.

The speech probability calculation module 103 may select one frame set among the first frames, the second frames, and the third frames, based on the first probability value and the second probability value. In the disclosure, the frame set may be used to refer to the first frames, the second frames, or the third frames selected for a specific time step. For example, one frame set may be A1, B1, or P1. In the disclosure, the frame sets may be used to inclusively refer to the first frames, the second frames, or the third frames selected for each of the plurality of time steps. For example, when A1, B2, and A3 are selected for the respective time steps T1, T2, and T3, the frame sets may include A1, B2, and A3. The speech probability calculation module 103 may calculate a first cumulative value by summing the first probability values calculated for each of the first target frames, and may calculate a second cumulative value by summing the second probability values calculated for each of the second target frames (S619). For example, the speech probability calculation module 103 may calculate the first cumulative value by summing the first probability values calculated for each of the 15 frames included in A1′, and may calculate the second cumulative value by summing the second probability values calculated for each of the 15 frames included in B1′. The first cumulative value may be ALip1, and the second cumulative value may be BLip1.

FIG. 6B is a diagram for explaining the operation of a preprocessing module and a speech probability calculation module according to another embodiment of the disclosure. FIG. 6B may represent the operation of the preprocessing module and the speech probability calculation module in a specific time step. For example, FIG. 6B may represent the operation of the preprocessing module and the speech probability calculation module in the time step T1, and the processes disclosed in FIG. 6B may be repeatedly performed for each time step. Hereinafter, it is assumed that the processes disclosed in FIG. 6B are processes performed during the time step T1.

Referring to FIG. 6B, the preprocessing module 101 may acquire first frames and second frames included in the time step T1. The first frames included in the time step T1 are expressed as Video A in FIG. 6B, and the second frames included in the time step T1 are expressed as Video B in FIG. 6B. Video A may be A1 of FIG. 2, and Video B may be B1 of FIG. 2.

The preprocessing module 101 may select first target frames among the plurality of frames included in the first frames and may select second target frames among the plurality of frames included in the second frames, based on effective time (S621). Since the process of selecting target frames from original frames has been described with reference to FIG. 5, the description thereof will be omitted herein. For example, when the effective time is 0.5 seconds, the preprocessing module 101 may select 15 frames, which are even-numbered frames, among 30 frames included in A1, and may select 15 frames, which are even-numbered frames, among 30 frames included in B1. The target frames selected from A1 may be expressed as A1′, and the target frames selected from B1 may be expressed as B1′.

The preprocessing module 101 may detect one or more of face regions or lip regions of an object from the selected first target frames and second target frames. The preprocessing module 101 may detect lip regions of a first object from the selected first target frames, and may detect lip regions of a second object from the selected second target frames (S623). The preprocessing module 101 may extract one or more lip feature points from the lip regions of the first object, and may extract one or more lip feature points from the lip regions of the second object (S625).

The speech probability calculation module 103 may acquire the lip feature points extracted by the preprocessing module 101. The lip feature points for the first target frames and the lip feature points for the second target frames may be distinguished from each other.

The speech probability calculation module 103 may calculate a speech probability of a first object based on lip feature points for the first target frames, and may calculate a speech probability of a second object based on lip feature points for the second target frames (S627). The speech probability may be calculated for each frame. For example, the speech probability calculation module 103 may calculate the speech probability of the first object for an n-th frame among the first target frames, may calculate the speech probability of the second object for an n-th frame among the second target frames, and may repeatedly perform the above processes for each frame. n may be the number of frames included in the first target frames or the number of frames included in the second target frames. For example, when the number of frames included in A1’ is 15 and the number of frames included in B1’ is 15, the speech probability calculation module 103 may perform a process of calculating the speech probability of the first object and the speech probability of the second object for each of the 1st to 15th frames, respectively. The 1st to 15th frames included in A1', that is, the 15 frames, may be even-numbered frames among the 30 frames included in A1. The 1st to 15th frames included in B1', that is, the 15 frames, may be even-numbered frames among the 30 frames included in B1. The speech probability of the first object for the n-th frame may be ALip1,n, and the speech probability of the second object calculated for the n-th frame may be BLip1,n. The speech probability of the first object calculated for a specific frame may be a first probability value. The speech probability of the second object calculated for a specific frame may be a second probability value. That is, the speech probability calculation module 103 may calculate, for each of the first target frames included in each time step, a first probability value indicating the speech probability of the first object, and for each of the second target frames included in each time step, a second probability value indicating the speech probability of the second object. The first probability value and the second probability value for each frame may be matched to each frame and stored as information for each frame.

The process of calculating the speech probability of the first object based on the lip feature points extracted from the lip regions of the first object included in the first target frames and the process of calculating the speech probability of the second object based on the lip feature points extracted from the lip regions of the second object included in the second target frames may be performed as separate processes simultaneously. That is, the process of calculating the speech probability of the first object based on the lip feature points extracted from the lip regions of the first object included in the first target frames and the process of calculating the speech probability of the second object based on the lip feature points extracted from the lip regions of the second object included in the second target frames may be performed in parallel.

The speech probability calculation module 103 may select one frame set among the first frames, the second frames, and the third frames, based on the first probability value and the second probability value. The speech probability calculation module 103 may calculate a first cumulative value by summing the first probability values calculated for each of the first target frames, and may calculate a second cumulative value by summing the second probability values calculated for each of the second target frames (S629). For example, the speech probability calculation module 103 may calculate the first cumulative value by summing the first probability values calculated for each of the 15 frames included in A1′, and may calculate the second cumulative value by summing the second probability values calculated for each of the 15 frames included in B1′. The first cumulative value may be ALip1, and the second cumulative value may be BLip1.

FIG. 7 is a diagram for explaining operations of a frame selection module and a final video generation module according to an embodiment of the disclosure.

Referring to FIG. 7, the frame selection module 105 may acquire a first cumulative value and a second cumulative value for each time step. A first cumulative value for an arbitrary time step m is ALipm, and a second cumulative value is BLipm. m is a natural number and may represent the time step. For example, when m is 1, it may mean the time step T1. As another example, when m is 2, it may mean the time step T2.

The frame selection module 105 may select one frame set from among the first frames, the second frames, and the third frames based on the first probability value and the second probability value. The frame selection module 105 may select one frame set based on a first cumulative value generated by summing the first probability values calculated for each of the first target frames and a second cumulative value generated by summing the second probability values calculated for each of the second target frames (S701). The process of selecting one frame set may include selecting any one from among the first frames, the second frames, and the third frames. For example, the frame selection module 105 may acquire the first cumulative value ALipm and the second cumulative value BLipm for an arbitrary time step m, and may select any one from among the first frames Am, the second frames Bm, and the third frames Pm based on the first cumulative value ALipm and the second cumulative value BLipm. Am may be a video for the arbitrary time step m among the first video 21, Bm may be a video for the arbitrary time step m among the second video 23, and Pm may be a video for the arbitrary time step m among the third video 25. For example, when m is 1, it means the time step T1, so A1 may be A1 of FIG. 2, B1 may be B1 of FIG. 2, and P1 may be P1 of FIG. 2.

The frame selection module 105 may select one frame set based on one or more of whether the difference between the first cumulative value and the second cumulative value is equal to or less than a threshold, and whether the first cumulative value is equal to or less than the second cumulative value. The frame selection module 10 may select the third frames when the difference between the first cumulative value and the second cumulative value is equal to or less than the threshold. The third frames may be Pm. The frame selection module 10 may select the first frames or the second frames when the difference between the first cumulative value and the second cumulative value is greater than the threshold. The frame selection module 10 may select the first frames when the difference between the first cumulative value and the second cumulative value is greater than the threshold and the first cumulative value is greater than the second cumulative value. The first frames may be Am. The frame selection module 10 may select the second frames when the difference between the first cumulative value and the second cumulative value is greater than the threshold and the first cumulative value is less than the second cumulative value. The second frames may be Bm.

The frame selection module 105 may repeatedly perform the process S701 for a plurality of time steps. That is, when the first video 21, the second video 23, and the third video 25 each include m time steps, the frame selection module 105 may perform the process S701 m times.

The final video generation module 107 may generate a final video based on the plurality of frame sets selected for each time step (S703). The final video generation module 107 may generate the final video by arranging and merging the plurality of selected frame sets in chronological order. Based on the threshold of the process S701, various final videos 71, 73, 75 may be generated. For example, in the case of the first final video 71 and the second final video 73, the first frames A5 may be selected for the time step T5, but in the case of the third final video 75, the third frames P5 may be selected for the time step T5.

Optionally, the final video generation module 107 may perform the smoothing process. The smoothing process may mean a process of replacing abnormal frames with normal frames if there are abnormal frames among the frames included in the generated final video. In other words, the final video generation module 107 may determine whether an abnormal frame set is present among the arranged frame sets, and replace the abnormal frame set with the normal frame set when the abnormal frame set is present. The final video generation module 107 may perform the smoothing process by using a smoothing algorithm.

The final video generation module 107 may perform the smoothing process by applying the smoothing algorithm to the frame set for each time step. As a result of the smoothing, the modified final video may include frame sets for each time step. Based on the number of time steps included in the final video, the number of frame sets included in the modified final video may vary.

The final video generation module 107 may determine that a specific type of frame set is an abnormal frame set when that frame set is not maintained for a predetermined time, and replace the abnormal frame set with the normal frame set. In other words, the final video generation module 107 may determine whether frames are maintained for a predetermined time, and determine that frames as abnormal frames when they are not maintained for the predetermined time, and replace the abnormal frames with normal frames. The final video generation module 107 may determine whether the number of consecutive frames included in the final video is less than a threshold, and determine whether a specific type of frames is maintained for a predetermined time based on the determination result.

The normal frame set may be a frame set of a different type from the abnormal frame set, which is acquired in the time step to which the abnormal frame set belongs. The frame set of a different type from the abnormal frame set may be a type of frame set adjacent to the abnormal frame set. The adjacent frame set may be a frame set acquired in a previous time step of the time step to which the abnormal frame set belongs, when there is a time step preceding the time step to which the abnormal frame set belongs. The adjacent frame set may be a frame set acquired in a subsequent time step of the time step to which the abnormal frame set belongs, when there is no time step preceding the time step to which the abnormal frame set belongs.

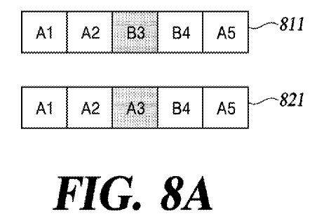

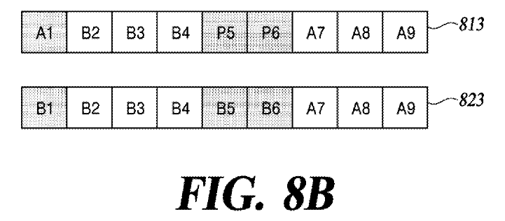

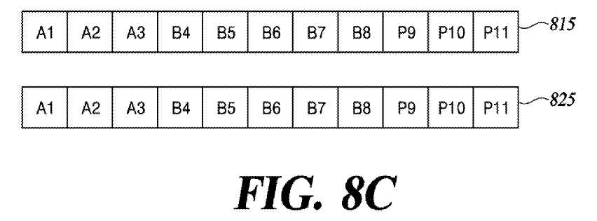

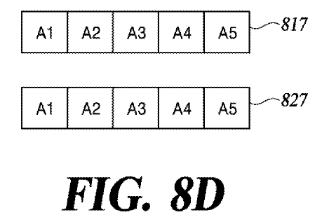

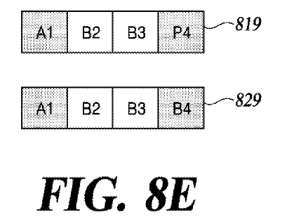

FIG. 8A is a diagram for explaining a smoothing process according to an embodiment of the disclosure. Referring to FIG. 8A, the final video 811 may include frame sets for each of T1 to T5, a total of five time steps. The final video generation module 107 may determine B3 where the number of consecutive frames is less than a threshold, among the plurality of frame sets A1, A2, B3, A4, A5 included in the final video 811, as an abnormal frame set. In other words, the final video generation module 107 may determine that B3, which is a frame set including the second frames belonging to the time step T3, is not maintained for a predetermined time. Since there is a time step preceding the time step T3 to which the abnormal frame set belongs, the final video generation module 107 may determine the type of the frame set A2 acquired in the preceding time step T2, that is, the first frames, as the type of the normal frame set. The final video generation module 107 may determine A3, which is the first frames acquired in the time step T3 to which the abnormal frame set belongs, as the normal frame set. The final video generation module 107 may replace the abnormal frame set B3 with the normal frame set A3. As a result of the replacement, a modified final video 821 may be generated. The output module 109 may output the modified final video 821 in which the smoothing process has been performed.

FIG. 8B is a diagram for explaining a smoothing process according to an embodiment of the disclosure. Referring to FIG. 8B, the final video 813 may include frame sets for each of T1 to T9, a total of nine time steps. The final video generation module 107 may determine A1, P5, P6 where the number of consecutive frames is less than a threshold, among the plurality of frame sets A1, B2, B3, B4, P5, P6, A7, A8, A9 included in the final video 813, as abnormal frame sets. In other words, the final video generation module 107 may determine A1, which is a frame set including the first frames belonging to the time step T1, P5, which is a frame set including the third frames belonging to the time step T5, and P6, which is a frame set including the third frames belonging to the time step T6, as abnormal frame sets. That is, the final video generation module 107 may determine that A1, which is a frame set including the first frames belonging to the time step T1, P5, which is a frame set including the third frames belonging to the time step T5, and P6, which is a frame set including the third frames belonging to the time step T6, are not maintained for a predetermined time. For the first frames belonging to the time step T1, since there is no time step preceding the time step T1, the final video generation module 107 may determine the type of frame set B2 acquired in the subsequent time step T2, i.e., the second frames, as the type of normal frame set. The final video generation module 107 may determine B1, which is the second frames acquired in the time step T1 to which the abnormal frame set belongs, as the normal frame set. The final video generation module 107 may replace the abnormal frame set A1 with the normal frame set B1. For the third frames belonging to the time step T5 and the third frames belonging to the time step T6, since there are time steps preceding the time steps T5 and T6, the final image generation module 107 may determine the type of the frame set B4 acquired in the preceding time step T4, i.e., the second frames, as the type of normal frame set. The final video generation module 107 may determine B5 and B6, which are second frames acquired in the time steps T5 and T6 to which the abnormal frame sets belong, as normal frame sets. The final video generation module 107 may replace the abnormal frame sets P5 and P6 with the normal frame sets B5 and B6. As a result of the replacement, a modified final video 823 may be generated. The output module 109 may output the final video 823 in which the smoothing process has been performed.

FIG. 8C is a diagram for explaining a smoothing process according to an embodiment of the disclosure. Referring to FIG. 8C, the final video 815 may include frame sets for each of T1 to T11, a total of eleven time steps. The final video generation module 107 may determine that, among the plurality of frame sets A1, A2, A3, B4, B5, B6, B7, P8, P9, P10, P11 included in the final video 815, there is no frame set where the number of consecutive frames is less than a threshold. In other words, the final video generation module 107 may determine that there is no abnormal frame set that is not maintained for a predetermined time. The final video generation module 107 may not replace any frame set among the frame sets included in the final video 815. As a result, the final video 825 may be generated. The output module 109 may output the final video 825 in which the smoothing process has been performed.

FIG. 8D is a diagram for explaining a smoothing process according to an embodiment of the disclosure. Referring to FIG. 8D, the final video 817 may include frame sets for each of T1 to T5, a total of five time steps. The final video generation module 107 may determine that, among the plurality of frame sets A1, A2, A3, A4, A5 included in the final video 817, there is no frame set where the number of consecutive frames is less than a threshold. In other words, the final video generation module 107 may determine that there is no abnormal frame set that is not maintained for a predetermined time. The final video generation module 107 may not replace any frame set among the frame sets included in the final video 817. As a result, the final video 827 may be generated. The output module 109 may output the final video 827 in which the smoothing process has been performed.

FIG. 8E is a diagram for explaining a smoothing process according to an embodiment of the disclosure. Referring to FIG. 8E, the final video 819 may include frame sets for each of T1 to T4, a total of four time steps. The final video generation module 107 may determine A1, P4 where the number of consecutive frames is less than a threshold, among the plurality of frame sets A1, B2, B3, P4 included in the final video 819, as abnormal frame sets. In other words, the final video generation module 107 may determine A1, which is a frame set including the first frames belonging to the time step T1, P4, which is a frame set including the third frames belonging to the time step T4, as abnormal frame sets. That is, the final video generation module 107 may determine that A1, which is a frame set including the first frames belonging to the time step T1, P4, which is a frame set including the third frames belonging to the time step T4, are not maintained for a predetermined time. For the first frames belonging to the time step T1, since there is no time step preceding the time step T1, the final video generation module 107 may determine the type of frame set B2 acquired in the subsequent time step T2, i.e., the second frames, as the type of normal frame set. The final video generation module 107 may determine B1, which is the second frames acquired in the time step T1 to which the abnormal frame set belongs, as the normal frame set. The final video generation module 107 may replace the abnormal frame set A1 with the normal frame set B1. For the third frames belonging to the time step T4, since there are time steps preceding the time step T4, the final image generation module 107 may determine the type of the frame set B3 acquired in the preceding time step T3, i.e., the second frames, as the type of normal frame set. The final video generation module 107 may determine B4, which are second frames acquired in the time step T4 to which the abnormal frame sets belong, as normal frame set. The final video generation module 107 may replace the abnormal frame set P4 with the normal frame set B4. As a result of the replacement, a modified final video 829 may be generated. The output module 109 may output the final video 829 in which the smoothing process has been performed.

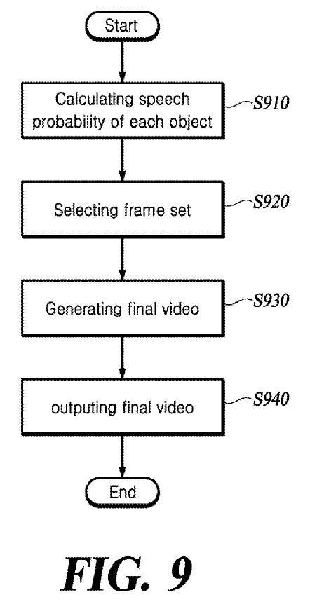

FIG. 9 is a flowchart schematically showing a video production method according to an embodiment of the disclosure.

Referring to FIG. 9, the apparatus for video production may calculate the speech probability for each object (S910). For each of the plurality of time steps, the apparatus for video production may calculate a first probability value indicating a speech probability of a first object included in each of the first frames included in each time step, and a second probability value indicating a speech probability of a second object included in each of a second frames included in each time step. Each of the first frames may include the first object, each of the second frames may include the second object, and each of the third frames may include both the first object and the second object.

The apparatus for video production may select a frame set (S920). For each of the plurality of time steps, the apparatus for video production may select one frame set from among the first frames included in each time step, the second frames included in each time step, and the third frames included in each time step, based on the first probability value and the second probability value.

The apparatus for video production may generate a final video (S930). The apparatus for video production may generate the final video based on the plurality of frame sets selected for the plurality of time steps.

The apparatus for video production may output the final video (S940). Optionally, the final video may be a final video on which a smoothing process has been performed.

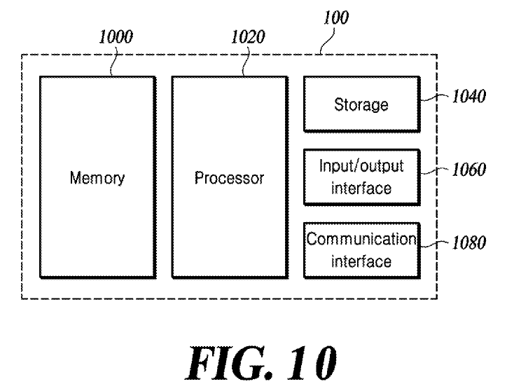

FIG. 10 is a block diagram illustrating an exemplary computing device that may be used for implementing a method or an apparatus according to the present disclosure.

The computing device 100 may include all or part of a memory 1000, a processor 1020, a storage 1040, an input/output interface 1060, and a communication interface 1080. The computing device 100 may be a stationary computing device, such as a desktop computer or a server, or a mobile computing device, such as a laptop computer or a smart phone. The computing device 100 may include a specialized hardware accelerator capable of processing operations of an artificial intelligence model in an efficient manner. For example, the computing device 100 may include a graphic processing unit (GPU), a tensor processing unit (TPU), or a neural processing unit (NPU).

The memory 1000 may store a program that enables the processor 1020 to perform methods or operations according to various embodiments of the present disclosure. For example, a program may include a plurality of instructions executable by the processor 1020, and the methods or operations described above may be performed by executing the plurality of instructions by the processor 1020. The memory 1000 may consist of a single memory or a plurality of memories. In this case, information required to perform the methods or operation according to various embodiments of the present disclosure may be stored in a single memory or distributed across a plurality of memories. When the memory 1000 is composed of a plurality of memories, the plurality of memories may be physically separated. The memory 1000 may include at least one of volatile memory and non-volatile memory. Volatile memory includes Static Random Access Memory (SRAM) or Dynamic Random Access Memory (DRAM), while non-volatile memory includes flash memory.

The processor 1020 may include at least one core capable of executing at least one instruction. The processor 1020 may execute instructions stored in the memory 1000. The processor 1020 may consist of a single processor or a plurality of processors.

The storage 1040 maintains stored data even if power supplied to the computing device 100 is cut off. For example, the storage 1040 may include non-volatile memory or may include a storage medium such as a magnetic tape, an optical disk, or a magnetic disk. A program stored in the storage 1040 may be loaded into the memory 1000 before being executed by the processor 1020. The storage 1040 may store files written in a program language, and a program created from the files by a compiler may be loaded into the memory 1000. The storage 1040 may store data to be processed by the processor 1020 and/or data processed by the processor 1020.

The input/output interface 1060 may provide an interface with an input device such as a keyboard or a mouse and/or an output device such as a display device or a printer. The user may trigger execution of a program by the processor 1020 through the input device and/or check the processing results of the processor 1020 through the output device.

The communication interface 1080 may provide access to an external network. The computing device 100 may communicate with other devices through the communication interface 1080.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

What is claimed:

1. A method for automated video production, comprising:
calculating, for each of a plurality of time steps, a first probability value indicating a speech probability of a first object included in each of first frames included in each time step, and a second probability value indicating a speech probability of a second object included in each of second frames included in each time step;
selecting, for each of the plurality of time steps, one frame set from among the first frames included in each time step, the second frames included in each time step, and third frames included in each time step, based on the first probability value and the second probability value;
generating a final video based on a plurality of frame sets selected for the plurality of time steps; and
outputting the final video,
wherein each of the first frames includes the first object, each of the second frames includes the second object, and each of the third frames includes both the first object and the second object.

2. The method of claim 1, further comprising:
prior to calculating the first probability value and the second probability value, for each of the first frames and for each of the second frames,
detecting, from the first frames and the second frames, one or more of face regions of an object or lip regions of the object; and
extracting one or more lip feature points from the lip regions of the object.

3. The method of claim 1, further comprising:
selecting, based on effective time, first target frames from the first frames and second target frames for the second frames, for a plurality of frames among the first frames and the second frames.

4. The method of claim 3, wherein
calculating the first probability value and the second probability value comprises:
calculating a speech probability of the first object based on lip feature points extracted from lip regions included in the first frames; and
calculating a speech probability of the second object based on lip feature points extracted from lip regions included in the second frames,
wherein the calculating the speech probability of the first object and the calculating the speech probability of the second object are separate processes that may be performed simultaneously.

5. The method of claim 3, wherein
calculating the first probability value and the second probability value comprises:
calculating the speech probability of the first object based on lip feature points extracted from lip regions included in the first target frames; and
calculating a speech probability of the second object based on lip feature points extracted from lip regions included in the second target frames,
wherein the calculating the speech probability of the first object and the calculating the speech probability of the second object are separate processes that may be performed simultaneously.

6. The method of claim 3,
selecting one frame set from among the first frames, the second frames, and the third frames based on the first probability value and the second probability value comprises:
calculating a first cumulative value representing the speech probability of the first object included in the first frames by summing the first probability values calculated for each of the first target frames, and calculating a second cumulative value representing the speech probability of the second object included in the second frames by summing the second probability values calculated for each of the second target frames; and
selecting the one frame set based on the first cumulative value and the second cumulative value.

7. The method of claim 6, wherein
selecting of the one frame set based on the first cumulative value and the second cumulative value comprises:
selecting the one frame set based on one or more of whether a difference between the first cumulative value and the second cumulative value is equal to or less than a threshold, and whether the first cumulative value is equal to or less than the second cumulative value.

8. The method of claim 7, wherein
selecting the one frame set based on one or more of whether a difference between the first cumulative value and the second cumulative value is equal to or less than a threshold, and whether the first cumulative value is greater than the second cumulative value comprises:
selecting the third frames when the difference between the first cumulative value and the second cumulative value is equal to or less than the threshold;
selecting the first frames when the difference between the first cumulative value and the second cumulative value is greater than the threshold and the first cumulative value is greater than the second cumulative value; and
selecting the second frames when a difference between the first cumulative value and the second cumulative value is greater than the threshold and the first cumulative value is less than the second cumulative value.

9. The method of claim 1, wherein
generating the final video comprises:
arranging the plurality of frame sets in chronological order;
determining whether an abnormal frame set is present among the arranged frame sets; and
replacing the abnormal frame set with a normal frame set when the abnormal frame set is present.

10. An apparatus for automated video production, comprising:
at least one memory storing instructions; and
at least one processor configured to execute the instructions to perform operations comprising: calculating, for each of a plurality of time steps, a first probability value indicating a speech probability of a first object included in each of first frames included in each time step, and a second probability value indicating a speech probability of a second object included in each of second frames included in each time step;
selecting, for each of the plurality of time steps, one frame set from among the first frames included in each time step, the second frames included in each time step, and third frames included in each time step, based on the first probability value and the second probability value;
generating a final video based on a plurality of frame sets selected for the plurality of time steps; and
outputting the final video,
wherein each of the first frames includes the first object, each of the second frames includes the second object, and each of the third frames includes both the first object and the second object.

11. The apparatus of claim 10, wherein
the processor is further configured to perform operations comprising:
prior to calculating the first probability value and the second probability value, for each of the first frames and for each of the second frames,
detecting, from the first frames and the second frames, one or more of face regions of an object or lip regions of the object; and
extracting one or more lip feature points from the lip regions of the object.

12. The apparatus of claim 10, wherein
the processor is further configured to perform operations comprising:
selecting, based on effective time, first target frames from the first frames and second target frames for the second frames, for a plurality of frames among the first frames and the second frames.

13. The apparatus of claim 12, wherein
calculating the first probability value and the second probability value comprises:
calculating a speech probability of the first object based on lip feature points extracted from lip regions included in the first frames; and
calculating a speech probability of the second object based on lip feature points extracted from lip regions included in the second frames,
wherein the calculating the speech probability of the first object and the calculating the speech probability of the second object are separate processes that may be performed simultaneously.

14. The apparatus of claim 12, wherein
calculating the first probability value and the second probability value comprises:
calculating the speech probability of the first object based on lip feature points extracted from lip regions included in the first target frames; and
calculating a speech probability of the second object based on lip feature points extracted from lip regions included in the second target frames,
wherein the calculating the speech probability of the first object and the calculating the speech probability of the second object are separate processes that may be performed simultaneously.

15. The apparatus of claim 12,
selecting one frame set from among the first frames, the second frames, and the third frames based on the first probability value and the second probability value comprises:
calculating a first cumulative value representing the speech probability of the first object included in the first frames by summing the first probability values calculated for each of the first target frames, and calculating a second cumulative value representing the speech probability of the second object included in the second frames by summing the second probability values calculated for each of the second target frames; and
selecting the one frame set based on the first cumulative value and the second cumulative value.

16. The apparatus of claim 15, wherein
selecting of the one frame set based on the first cumulative value and the second cumulative value comprises:
selecting the one frame set based on one or more of whether a difference between the first cumulative value and the second cumulative value is equal to or less than a threshold, and whether the first cumulative value is equal to or less than the second cumulative value.

17. The apparatus of claim 16, wherein
selecting the one frame set based on one or more of whether a difference between the first cumulative value and the second cumulative value is equal to or less than a threshold, and whether the first cumulative value is greater than the second cumulative value comprises:
selecting the third frames when the difference between the first cumulative value and the second cumulative value is equal to or less than the threshold;
selecting the first frames when the difference between the first cumulative value and the second cumulative value is greater than the threshold and the first cumulative value is greater than the second cumulative value; and
selecting the second frames when a difference between the first cumulative value and the second cumulative value is greater than the threshold and the first cumulative value is less than the second cumulative value.

18. The apparatus of claim 10, wherein
generating the final video comprises:
arranging the plurality of frame sets in chronological order;
determining whether an abnormal frame set is present among the arranged frame sets; and
replacing the abnormal frame set with a normal frame set when the abnormal frame set is present.
